(19) United States
(12) Patent Application Publication
(10) Pub. No.: US 2018/0017154 A1
(43) Pub. Date: Jan. 18, 2018

(54) Geared Turbocharged Engine

(71) Applicant: MAN DIESEL & TURBO SE, Augsburg (DE)

(72) Inventors: Kolja METZ, Berlin (DE); Christian WACKER, Berlin (DE)

(73) Assignee: MAN DIESEL & TURBO SE

(21) Appl. No.: 15/649,891

(22) Filed: Jul. 14, 2017

(30) Foreign Application Priority Data
Jul. 15, 2016 (DE) 102016113067.2

(51) Int. Cl. F16H 57/04; F01D 15/12; F02C 7/36; F04D 25/16

(52) U.S. Cl. CPC F16H 57/0434; F04D 25/163; F01D 15/12; F02C 7/36

(57) ABSTRACT

A geared turbocharged engine, having a gearbox, a drive and output assembly, and an oil supply system. The gearbox has a housing. The oil supply system has a reservoir, a supply line, an oil pump to convey oil from the reservoir, and a return line, to return oil from the gearbox to the reservoir. The housing is mounted on a support plate of reservoir a supply-line opening and a return-line opening are introduced into the housing and the support plate such that the supply-line opening of the support plate and the supply-line opening of the housing and the return-line opening of the gearbox and the return-line opening of the support plate are flush, so that the inflow of oil to the gearbox and the return flow of oil from the gearbox take place via the gearbox housing.

### BACKGROUND OF THE INVENTION

### 1. Field of the Invention

The invention relates to a geared turbocharged engine.

### 2. Description of the Related Art

The basic structure of a geared turbocharged engine a gearbox, having a drive assembly, and a plurality of output assemblies is known from DE 10 2012 022 131 A1, wherein these components of the geared turbocharged engine are integrated to form a machine train. The gearbox has a central gear wheel with a gear-wheel shaft and one or more pinion shafts mesh with the gear wheel.

Furthermore, it is already known from practice that a geared turbocharged engine has an oil supply system, in order to supply the gearbox of the geared turbocharged engine in particular with lubricating oil. Such an oil supply system of the geared turbocharged engine has an oil storage reservoir in which oil is held, an oil supply line by which oil can be drawn from the oil storage reservoir and guided in the direction of the gearbox to be lubricated, an oil pump for conveying the oil out of the oil storage reservoir, and an oil return line by which oil emanating from the gearbox flows back into the oil storage reservoir. In geared turbocharged engines known from practice, the oil supply line to the gearbox and the oil return line from the gearbox are realized by separate pipelines that are typically connected on the side to the gearbox housing of the gearbox. Pipelines of this type can only be adjusted after the geared turbocharged engine has been mounted in the field or has been connected to the oil system. The adjustment of the pipelines requires assembly time, as a result of which the total delivery time of the geared turbocharged engine is influenced.

There is a requirement for a geared turbocharged engine, in which it is possible to dispense with pipelines in the region of the gearbox and thus dispense with the adjustment of the same in the field.

### SUMMARY OF THE INVENTION

On this basis, it is an object of one aspect of the invention to create a novel geared turbocharged engine. The gearbox housing of the gearbox is mounted standing on a support plate of the oil storage reservoir by a gearbox housing base, wherein one supply-line opening and one return-line opening in each case are introduced into the gearbox housing base and into the support plate of the oil storage reservoir in such a manner that the supply-line opening of the support plate of the oil storage reservoir and the supply-line opening of the gearbox housing base of the gearbox housing and also the return-line opening of the gearbox housing base of the gearbox housing and the return-line opening of the support plate of the oil storage reservoir are flush in each case, so that the inflow of the oil to the gearbox and the return flow of the oil from the gearbox take place via the gearbox housing base in each case.

In the geared turbocharged engine according to one aspect of the invention, the gearbox housing of the gearbox is mounted standing on the support plate of the oil storage reservoir, specifically by the gearbox housing base, which is preferably screwed to the support plate of the oil storage reservoir. Supply-line openings for the supply line and return-line openings for the oil return line are introduced into the gearbox housing base of the gearbox housing and into the support plate of the oil storage reservoir. The supply of the oil in the direction of the gearbox therefore takes place by the supply-line openings of the support plate of the oil storage reservoir and gearbox housing base. The return flow of the oil emerging from the gearbox in the direction of the oil storage reservoir takes place via the return-line openings of gearbox housing base and support plate. Thus, it is possible to dispense with a separate pipe system in the region of the gearbox. Adjustment operations in the field are therefore superfluous. The total delivery time of a geared turbocharged engine can be reduced.

According to an advantageous development, the gearbox housing base and the support plate of the oil storage reservoir are sealed with respect to each other by a seal element at least in the region of the supply-line openings, wherein to this end, a groove is preferably introduced into the support plate of the oil storage reservoir surrounding the supply-line opening, into which groove a seal element constructed as an O-ring or as a sealing cord is inserted. Therefore, a separation gap between the flush supply-line openings of support plate of the oil storage reservoir and gearbox housing base of the gearbox housing can be sealed in a particularly advantageous manner. In this case, an overpressure of a few bars with respect to atmospheric pressure typically prevails in the supply region, so that the use of an O-ring, which is inserted into the groove of the support plate of the oil storage reservoir, enables a particularly advantageous seal.

According to a development, the gearbox housing base and the support plate of the oil storage reservoir are furthermore sealed with respect to each other in the region of the return-line openings by a seal element. A seal in the region of the return-line openings of the typically unpressurized return line is also preferred.

According to a development, a supply-side oil throttle is integrated into the gearbox housing. The integration of the supply-side oil throttle into the gearbox housing allows a further function integration and thus the reduction of the adjustment outlay required according to the prior art when building the geared turbocharged engine in the field.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred developments of the invention emerge from the dependent claims and the following description. Exemplary embodiments of the invention are explained in more detail on the basis of the drawing, without being limited thereto. In the figures:

FIG. 1 is a block diagram of a geared turbocharged engine;

FIG. 2 is a schematized, perspective view of a gearbox of the geared turbocharged engine with open gearbox housing together with an oil storage reservoir of the geared turbocharged engine; and

FIG. 3 is a view from below onto a gearbox base of the gearbox housing of the gearbox of the geared turbocharged engine.

### DETAILED DESCRIPTION OF THE PRESENTLY PREFERRED EMBODIMENTS

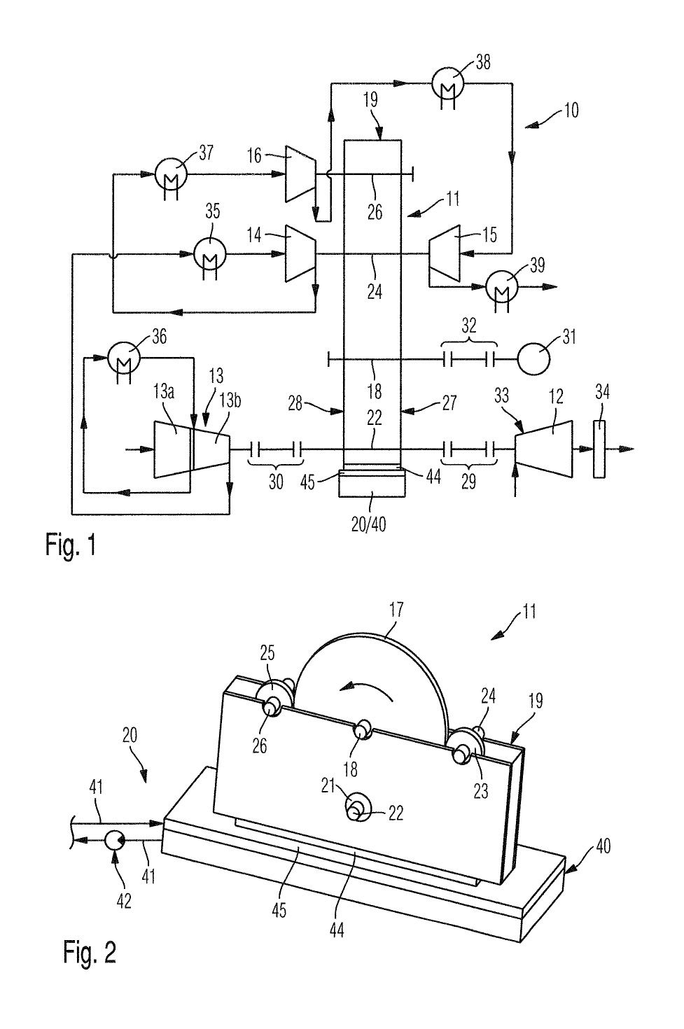

FIGS. 1 and 2 show an exemplary embodiment of a geared turbocharged engine 10. The geared turbocharged engine 10 comprises an integrated gearbox 11, a drive assembly 12, a plurality of output assemblies 13, 14, 15 and 16, wherein the gearbox 11, the drive assembly 12 and the plurality of output assemblies 13, 14, 15 and 16 are integrated to form a machine train. The geared turbocharged engine 10 furthermore comprises an oil supply system 20, by which the gearbox 11 in particular can be supplied with lubricating oil and/or cooling oil.

The gearbox 11 of the geared turbocharged engine 10 comprises a gear wheel 17, positioned on a gear-wheel shaft 18 and mounted in a rotatable manner in a gearbox housing 19 of the gearbox 11 by the gear-wheel shaft 18. A plurality of pinions 21, 23, 25 mesh into the gear wheel 17 of the gearbox 11 at the circumference of the same, which pinions are fastened onto pinion shafts 22, 24, 26 and are likewise mounted in a rotatable manner in the gearbox housing 19 by the pinion shafts 22, 24 and 26. In the exemplary embodiment, in total three such pinions 21, 23 and 25 mounted on pinion shafts 22, 24 and 26 mesh into the gear wheel 17 at the circumference of the gear wheel 11.

The drive assembly 12 is preferably constructed as a steam turbine, in which a first process gas is relaxed to provide mechanical drive power. The drive assembly 12 is coupled to a first pinion shaft 22 of the gearbox 11, namely on a first side 27 of the gearbox 11 or of the gearbox housing 19, wherein the drive assembly 12 constructed as a steam turbine is coupled by a first clutch 29 to the first pinion shaft 22.

The plurality of output assemblies 13, 14, 15 and 16 include a first output assembly 13 constructed as a main compressor and a plurality of second output assemblies 14, 15 and 16 constructed as geared compressors. The main compressor or the first output assembly 13 is constructed in at least two stages with the main-compressor stages 13a, 13b, wherein a second process gas is compressed in the main compressor using the mechanical drive power provided by the drive assembly 12.

The first drive assembly 13 or the main compressor is likewise coupled to the first pinion shaft 22 of the gearbox 11, namely on a second side 28 of the gearbox 11 or gearbox housing 19 opposite the first side 27. In this case, the first drive assembly 13 constructed as a main compressor engages via a second clutch 30 on the first pinion shaft 22, to which the drive assembly 12 is also coupled via the first clutch 29. Then, if the first clutch 29 and the second clutch 30 are both closed, the drive assembly 12 and the first output assembly 13 constructed as main compressor are in operative connection with one another directly without the interposition of a translation stage of the gearbox 11, so that the same rotate with the same speed.

The geared turbocharged engine 10 of FIGS. 1 and 2 comprises three second output assemblies 14, 15, and 16, which are constructed as geared compressors, in addition to the drive assembly 12 and the first output assembly 13, which is constructed as a main compressor. One, two, or more than three geared compressors may also be present. The second process gas is compressed further in the second output assemblies 14, 15 and 16, which are constructed as geared compressors, using the mechanical drive power provided by the drive assembly 12, wherein the second output assemblies 14, 15 and 16 are coupled with further pinion shafts 24, 26 of the gearbox 11.

Thus, in the exemplary embodiment of FIGS. 1 and 2, the three further second output assemblies 14, 15, and 16 are coupled to two further pinion shafts 24 and 26, namely in such a manner that the two geared compressors 14 and 15 are coupled to a second pinion shaft 24 of the gearbox 11 on opposite sides 27 and 28 of the gearbox 11 or gearbox housing 19, whereas the geared compressor 16 is coupled to a third pinion shaft 26 of the gearbox 11, preferably in the region of the side 28 of the gearbox housing 19 on which the geared compressor 14 and the main compressor 13 are also positioned.

The main compressor 13 is also termed the MAC compressor, the first main-compressor stage 13a of which is preferably an axial stage and the second main-compressor stage 13b of which is preferably a radial stage. However, a continuously axial construction is also conceivable.

The geared compressors 14, 15, and 16 are also termed boost compressors or BAC compressors. The geared compressors 14, 15, and 16 are preferably radial compressors. The unit made up of gearbox 11 and radial geared compressors 14, 15 and 16 is also termed the radial-gear compressor or the RG compressor.

In the exemplary embodiment of FIGS. 1 and 2, the first pinion shaft 22 is positioned together with the first pinion 21 mounted on the same approximately at the 6 o'clock position of the gear wheel 17 and meshes by means of the pinion 21 into the gear wheel 17 at this position. The second pinion shaft 24 with the pinion 23 is positioned approximately at the 3 o'clock position and the third pinion shaft 26 with the pinion 25 is positioned approximately at the 9 o'clock position of the gear wheel 17, wherein these pinions 23 and 25 mesh into the gear wheel 17 at these positions.

As shown in FIG. 1, an optional generator 31 or else an alternative motor can be coupled to the gear wheel 18 of the gearbox 11, namely by a clutch 32.

As already explained, the first output assembly 13 constructed as a main compressor is constructed in multiple stages with a plurality of compressor stages, wherein two main compressor stages 13a, 13b are shown in FIG. 1a.

In the region of the steam turbine or the drive assembly 12, an axial exhaust housing 33 is used, so that relaxed first process gas leaves the steam turbine 12 in the axial direction. Condenser 34 is positioned downstream of the steam turbine 12.

As can be seen from FIG. 1, the geared turbocharged engine 10 comprises a plurality of coolers 35, 36, 37, 38, and 39. The cooler 36 is an intercooler, which is connected between the two main-compressor stages 13a, 13b of the main compressor 13. The coolers 35, 37, and 38 are likewise intercoolers, namely cooler 35 is an intercooler between the second main compressor stage 13b and the first geared compressor 14, cooler 37 is an intercooler between the first geared compressor 14 and the second geared compressor 16 and cooler 38 is an intercooler between the second geared compressor 16 and the third geared compressor 15. Cooler 39 is a final cooler downstream of the third geared compressor 15.

As already explained above, the geared turbocharged engine 10 furthermore has the oil supply system 20, which provides the gearbox 11 in particular with lubricating oil.

The oil supply system 20 has an oil storage reservoir 40, in which oil for lubricating and/or cooling the gearbox 11 is held. Furthermore, the oil supply system 20 has an oil supply line 41, by which oil can be drawn from the oil storage reservoir 40 and conveyed in the direction of the gearbox 11, wherein, according to FIG. 2, an oil pump 42 is assigned to the oil supply line 41, which conveys the oil out of the oil storage reservoir 10.

An oil cooler, which is not shown, is furthermore typically assigned to the oil supply line 41, in order to cool the oil drawn from the oil storage reservoir 40.

Furthermore, a temperature regulating valve and a pressure regulating valve are typically additionally assigned to the oil supply line 41, in order on the one hand to regulate the oil temperature in the oil supply line 41 and on the other hand to set the oil quantity which is conveyed via the oil supply line 41 in the direction of the gearbox 11.

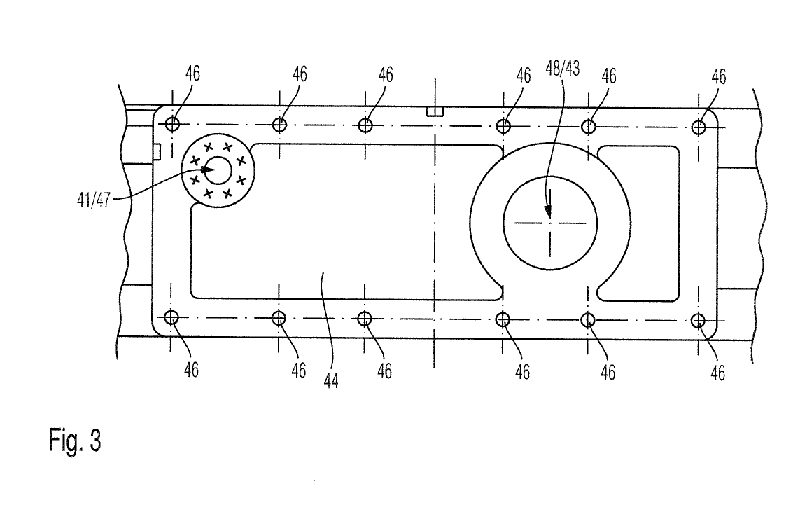

The gearbox housing 19 of the gearbox 11 is mounted standing on the oil storage reservoir 40, specifically in such a manner that the gearbox housing 19 is mounted standing on a support plate 45 of the oil storage reservoir 40 by a gearbox housing base 44, preferably by screws, which extend through mounting holes 46 of gearbox housing base 44 and support plate 45. FIG. 3 shows a view from below onto the gearbox housing base 44 of the gearbox housing 19 of the gearbox 11 and a plurality of such mounting holes 46, which are used for screwing the gearbox housing 19 to the support plate 45 of the oil storage reservoir 40 in the region of the gearbox housing base 44.

As explained already, the gearbox 11 is mounted standing on the support plate 45 of the oil storage reservoir 40 by the gearbox housing 19, namely the gearbox housing base 44. A supply-line opening 47 and a return-line opening 48 are introduced in each case into the gearbox housing base 44 of the gearbox housing 19 and into the support plate 45 of the oil storage reservoir 40.

The supply-line opening 47 of the support plate 45 of the oil storage reservoir 40 and the supply-line opening 47 of the gearbox housing base 44 of the gearbox housing 19 are flush with one another. Furthermore, the return-line opening 48 of the gearbox housing base 44 of the gearbox housing 19 and the return-line opening 48 of the support plate 45 of the oil storage reservoir 10 are flush. The supply-side inflow of the oil to the gearbox 11 and the return-side return flow of the oil from the gearbox 11 in each case take place via the gearbox housing base 44. Therefore, it is possible to dispense with a separate pipe system in the region of the gearbox housing 19 of the gearbox 11. Adjustment operations relating to this when building the geared turbocharged engine in the field become superfluous.

A pipe system, which is part of the oil system, is only required in the region of the supply line 41 between the oil storage reservoir 40 and the support plate 45 of the oil storage reservoir 40, namely for positioning the oil pump 42, the oil cooler, which is not shown, and also the valves, which are not shown. The transfer of the oil emanating from the support plate 45 of the oil storage reservoir 40 into the gearbox housing 19 and the return flow of the oil from the gearbox housing 19 into the support plate 45 of the oil storage reservoir 40 takes place via the openings in the gearbox housing base 44 and support plate 45, namely via the above-mentioned supply-line openings 47 and return-line openings 48.

The gearbox housing base 44 and the support plate 45 are sealed with respect to each other, specifically at least in the region of the supply-line openings 47 of gearbox housing base 44 and support plate 45 and also in the region of the return-line openings 48 of gearbox housing base 44 and support plate 45. In the region of the supply-line openings 47, the sealing in this case preferably takes place by a seal element constructed as an O-ring, which is inserted into a groove in the support plate 45 of the oil storage reservoir 40, wherein this groove runs around the supply-line opening 47 of the support plate 45 of the oil storage reservoir 40. By contrast, a flat seal or a curing sealing gel can also be used as seal element, however.

A groove in the gearbox base would also alternatively be possible, in this case the seal element would then have to be adapted and chosen in accordance with the geometries.

Sealing the flush or communicating supply-line openings 47 in the gearbox housing base 44 of the gearbox housing 19 and support plate 45 of the oil storage reservoir 40 by means of O-rings is preferred, as there is typically an overpressure of a few bars compared to atmospheric pressure on the supply side.

The sealing of the communicating or flush return-line openings 48 of the gearbox housing base 44 of the gearbox housing 19 and support plate 45 of the oil storage reservoir 20 can take place in an analogous manner as in the region of the supply-line openings 47, because the return flow is unpressurized however, lower demands are to be placed on the pressure-tightness than in the region of the supply-line openings 47.

Preferably, a supply-side oil throttle is furthermore integrated into the gearbox housing 19. Thus, the adaptation or adjustment outlay in the field can be reduced further.

Furthermore, a more compact construction of the geared turbocharged engine 10 with reduced space requirement can be provided.

The supply line of the oil supply line 41, into which the oil pump 42 and preferably the oil cooler are integrated, ends in the region of the support plate 45 of the oil storage reservoir 40, namely in the region of the supply-line opening 47 of the support plate 45 of the oil storage reservoir 40, which is flush or communicates with the supply-line opening 47 of the gearbox housing base 44.

Inside the gearbox housing 19, an oil distribution in the direction of the individual assemblies of the gearbox 11 to be lubricated can take place by means of holes and channels inside the housing wall of the gearbox housing 19.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A geared turbocharged engine, comprising: at least one drive and output assembly;
a gearbox comprising:
a gearbox housing;
a central gear wheel with a gear-wheel shaft; and
at least one pinion, with at least one pinion shaft, meshing into the central gear wheel; and
an oil supply system comprising:
a support plate;
an oil storage reservoir in which oil is held;
an oil supply line by which oil can be drawn from the oil storage reservoir and guided toward the gearbox to be lubricated;
an oil pump configured to convey the oil out of the oil storage reservoir, and
an oil return line by which oil emanating from the gearbox flows back into the oil storage reservoir;
wherein:
the gearbox housing is mounted standing on the support plate by a gearbox housing base;
a supply-line opening and a return-line opening are introduced into each of the gearbox housing base and the support plate such that the supply-line opening of the support plate and the supply-line opening of the gearbox housing base are flush and the return-line opening of the gearbox housing base and the return-line opening of the support plate,
whereby inflow of the oil to the gearbox and return flow of the oil from the gearbox take place via the gearbox housing base.

2. The geared turbocharged engine according to claim 1, wherein the gearbox housing base and the support plate are sealed with respect to each other at least in a region of the supply-line openings by a seal element.

3. The geared turbocharged engine according to claim 2, wherein a groove is introduced into the support plate surrounding the supply-line opening, into which groove a seal element configured as an O-ring is inserted.

4. The geared turbocharged engine according to claim 2, wherein the seal element is a flat seal.

5. The geared turbocharged engine according to claim 2, wherein the seal element is a cured sealing gel.

6. The geared turbocharged engine according to claim 2, wherein the gearbox housing base and the support plate are sealed with respect to each other in a region of the return-line openings by a seal element.

7. The geared turbocharged engine according to claim 6, wherein a groove is introduced into the support plate surrounding the return-line opening, into which groove a seal element configured as an O-ring is inserted.

8. The geared turbocharged engine according to claim 6, wherein the seal element is a flat seal.

9. The geared turbocharged engine according to claim 6, wherein the seal element is a cured sealing gel.

10. The geared turbocharged engine according to claim 1, further comprising a supply-side oil throttle integrated into the gearbox housing.
